(19) United States
(12) Patent Application Publication
(10) Pub. No.: US 2020/0396794 A1
(43) Pub. Date: Dec. 17, 2020

(54) METHOD FOR DATA TRANSMISSION IN A NETWORK, SUBSCRIBER AND NETWORK FOR TRANSMITTING DATA PACKETS

(71) Applicant: SIEMENS MOBILITY GMBH, MUENCHEN (DE)

(72) Inventors: LARS BRO, OLSTYKKE (DK); JOACHIM SCHUMACHER, HOHNE (DE); MIKAEL VOSS, BERLIN (DE)

(21) Appl. No.: 16/971,810

(22) PCT Filed: Jan. 23, 2019
(86) PCT No.: PCT/EP2019/051535

§ 371 Date: Aug. 21, 2020

(30) Foreign Application Priority Data
Feb. 21, 2018 (DE) 10 2018 202 638.6

(51) Int. Cl. H04W 84/18; H04W 40/24; H04W 40/12; H04L 29/08; H04L 29/06

(52) U.S. Cl. CPC H04W 84/18; H04W 40/246; H04L 69/22; H04L 67/12; H04W 40/12

(57) ABSTRACT

In a method for data transmission in a network containing multiple subscribers, a uniquely identifiable data packet is sent from at least one first subscriber to all adjacent second subscribers. The data packet is received by each second subscriber and it being ascertained whether the data packet has already been received and/or sent by this second subscriber previously. Further, the method involves the data packet being sent from each second subscriber to all adjacent third subscribers if the respective second subscriber had not yet received and/or sent the data packet previously. The method allows a high level of transmission quality to be achieved. A subscriber for receiving and transmitting data packets in a network and a network for transmitting data packets having multiple subscribers uses such a method.

In known networks for transmitting data packets, subscribers are present which send and receive the data packets. In this context, the subscribers are equipment for electronic data processing, which are embodied for receiving, processing and transmitting the data packets. The subscribers of such a data network also may alternatively be referred to as nodes. In many known networks, a reliable transfer of data packets between the subscribers is desired. This reliability, which may also be referred to as QoS (Quality of Service), of a transfer is the probability with which a data packet is received by its destination. Subscribers of the network may transfer the data packets to other subscribers, to which they are connected. The data transfer between the subscribers is not always reliable and may, for example, be disrupted by a movement of mobile subscribers, by the transfer capacity being exceeded, by a failure or overloading of subscribers, by disruptions to or failure of the transfer technology or by other properties of the data transfer technology or of the subscribers. Examples of networks, in which such a disruption to the data transfer may be problematic, are data transfers of train protection equipment between train-side equipment and track-side equipment, data transfers between mobile and stationary automation devices in industrial manufacturing facilities or also data transfers between motor vehicles and stationary road transport equipment.

The data transfer within a network may take place from a subscriber to one or more other connected subscribers. In the simplest case, the sending subscriber is identical to the origin of the data transfer and the receiving subscriber is identical to the destination of the data transfer. In most cases, however, no direct connection exists between the origin subscriber and the destination subscriber. In this case, a data transfer takes place indirectly via one or more subscribers which forward the data packet.

A data packet is a defined unit of data, which is transferred and processed together. In this context, a data packet at least contains information regarding the destination of the transmission. This destination may be a single subscriber (Unicast or Anycast), a defined subset of the subscribers (Multicast) or may also be all the subscribers (Broadcast) of the network.

The connections between the subscribers may be realized via different data transfer technologies. The transfer may take place by cable, wirelessly or in other ways, for example. The connection may exist in the form of a physical or logical direct connection to another subscriber (point-to-point connection) or an undirected transmission to multiple nodes. In this context, the connections do not have to be static, but rather they may also vary, for example due to a movement of mobile subscribers or due to variations in the ambient conditions. The connections between the subscribers usually have a limited transfer capacity.

Errors in the data transfer may be identified by error detection mechanisms, and incorrectly transferred data packets may be discarded by subscribers. Some known data transfer systems are even able to correct transfer errors to a limited extent by way of error correction mechanisms.

Nevertheless, a reliable transfer of data packets between the subscribers in networks is desirable.

In known methods, a data packet is sent in a targeted manner from a subscriber to a connected next subscriber, until the data packet reaches its destination. In this context, the path can be determined by a routing protocol, by way of which the subscribers determine the connection between themselves to the destination. This method is particularly suitable for transfers where the destination is a single subscriber (Unicast, Anycast).

In the known methods, however, it is possible for errors to occur frequently, meaning that the transfer quality is not always sufficient.

The object underlying the invention is therefore to provide a method for data transmission in a network and a subscriber of such a network, in which the quality of the data transfer can be increased.

The invention achieves this object by way of a method for data transmission in a network consisting of a plurality of subscribers, in which a uniquely identifiable data packet is sent from at least one first subscriber to all adjacent second subscribers, in which the data packet is received by each second subscriber and it is determined whether the data packet has previously already been received and/or sent by said second subscriber, and in which the data packet is sent by each second subscriber to all adjacent third subscribers if the respective second subscriber had not yet previously received and/or sent the data packet.

Furthermore, the invention achieves the object by way of a subscriber for receiving and transmitting data packets in a network consisting of a plurality of subscribers, wherein the subscriber is embodied to receive a data packet transmitted by an adjacent subscriber and to determine whether the data packet has previously already been received and/or sent by the subscriber, and the subscriber is embodied to send the data packet to all adjacent subscribers if the subscriber has not yet previously received and/or sent the data packet.

The solution according to the invention has the advantage on the one hand that the entire network of subscribers is supplied or flooded with the data packet, ensuring a reliable transmission to the destination as a result. Specifically, various paths are advantageously used. Here, the destination may also consist of a plurality of or all the subscribers of the network (Multicast, Broadcast). For this purpose, the data packet is sent by the subscribers to all adjacent subscribers in each case. The data packet is accordingly duplicated or copied for this. On the other hand, the invention avoids an unnecessary loading of the network, because each second subscriber only sends the data packet to the adjacent third subscribers if the respective second subscriber had not yet previously sent or received the data packet. A multiple transmission from the same subscriber is therefore avoided. This minimizes the data traffic in the network.

The invention can be developed by advantageous embodiments, which are described below.

Thus, in an advantageous development of the method according to the invention, the received data packet is not sent by each of the second subscribers when said second subscriber had previously already received and/or sent the data packet, or said second subscriber is the sole destination of the data packet. Furthermore, the received data packet may be deleted if the respective second subscriber had previously already received and/or already sent the data packet. This has the advantage that already received and/or already sent data packets do not have to be temporarily stored at the subscribers.

In order to have to transmit fewer data packets overall and to transfer useful data in sufficient volumes, a data volume greater than 128 bytes can be sent or received together by means of the data packet. For the transmission of useful data, a data volume greater than 128 bytes is sensible. Considerably larger data volumes are naturally also possible.

In order to easily determine whether data packets have already been sent or received at a second subscriber, it can be determined with the aid of an identification means, which has the data packet, whether the second subscriber had previously already received and/or sent the data packet.

Furthermore, the data packet cannot be sent back to the first subscriber by each second subscriber. This has the advantage that the data traffic in the network is reduced, because the first subscriber has already seen the data packet received by the second subscriber in any case.

Finally, the invention also relates to a network for transmitting data packets with a plurality of subscribers, in which according to the invention at least some of the subscribers are configured in accordance with the aforementioned embodiment of the invention.

In an advantageous embodiment, the network may be configured as an ad hoc network. The invention is particularly well-suited for the embodiment of such ad hoc networks.

Furthermore, the network may be configured within a railway engineering system, an industrial facility or a road traffic system.

The invention will be described below making reference to the accompanying drawings, in which:

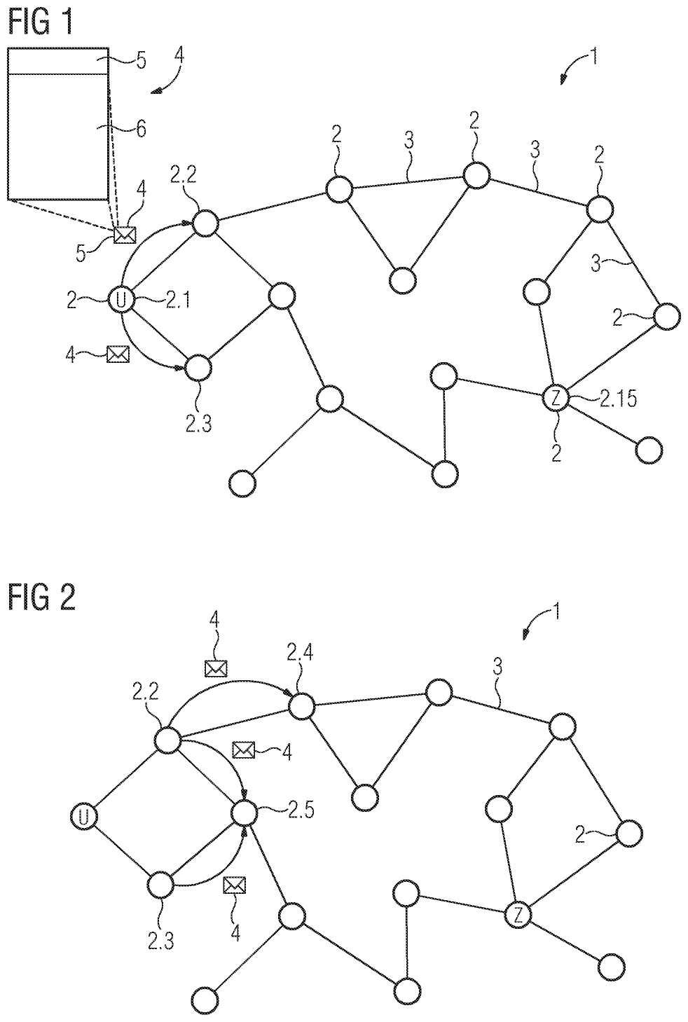

FIGS. 1-6 show schematic representations of an exemplary embodiment of a network according to the invention in different steps of a data transfer according to the invention.

The invention is described below with the aid of an exemplary embodiment of the network according to the invention in FIGS. 1-6.

FIGS. 1-6 each show a network 1 with a large number of subscribers 2, which are at least partially interconnected by connections 3. The subscribers 2 forming the network 1 are, for example, various pieces of vehicle-side or track-side train protection equipment of a railway engineering system, between which a data transfer takes place. The connections 3 between the subscribers 2 should be configured as wireless here by way of example. Alternatively, however, the connections 3 may also be designed as using cables or in other ways. The connections 3 also do not have to be static, but rather may vary due to a movement of the mobile subscribers 2. The schematic representation in FIGS. 1-6 is therefore to be considered a snapshot.

Furthermore, in FIGS. 1-6 a data packet 4 is shown, which is transferred between particular subscribers 2. The direction of the transfer of the data packet 4 between the subscribers 2 is indicated by an arrow. In the following, the subscribers 2 are marked with different reference characters for the purpose of differentiation.

In the following, it is explained how a data packet 4, with the aid of the method according to the invention, from an origin subscriber 2.1, which forms the origin U of the data packet 4, to a subscriber 2.15, which represents the destination Z of the data packet 4.

The data packet 4 is created by the subscriber 2.1 at its origin U. The destination Z of the data packet 4 should be the subscriber 2.15, which is specified in the data packet 4. Furthermore, the data packet 4 has a unique identification means 5m by way of which the data packet 4 can be uniquely identified. The identification means 5 is an identifier, for example such as a cryptographic message authentication code, a combination of sender ID and sequence number, a randomly generated packet ID or any other ID, which uniquely identifies the data packet 4 after its original transmission.

All the subscribers 2, 2.1-2.15 of the network 1 are embodied such that they record the identification means 5 of all the data packets 4 which they receive and/or send. This enables them to check whether a new data packet 4 has already previously been received. When talking about the data packet 4 or the data packets 4, this always means the identical data packet 4 and its duplicated data packets 4. Other new data packets with different content are not shown in the figures.

In addition to the identification means 5, however, the data packet 4 also has useful data 6, the transmission of which is the actual purpose of the data transfer. Useful data 6 for example may be information of a piece of train protection equipment, which has to be transmitted to another subscriber 2. In FIG. 1, the data packet 4 is shown once, schematically and enlarged, in order to show the different contents.

As the data packet 4 cannot be transferred directly from its origin U to its destination Z, because the corresponding subscribers 2 are not all directly interconnected, the data packet 4 has to be transferred via other subscribers 2, which lie between origin U and destination Z. In order to transfer the data packet 4, each subscriber 2 transmits the data packet 4 to all subscribers 2 adjacent to it, with the exception of the subscriber 2 from which the data packet 4 has been received. Alternatively, the data packet 4 may also be sent to the subscriber 2 from which the data packet 4 has been received, if it is technically impossible to proceed otherwise for example. This is necessary for example if only one radio channel is available for transmission.

For the transfer of the data packet 4 to all adjacent subscribers 2, the data packet is reproduced by the transmitting subscriber 2 as appropriate, in order to be able to send one version to each subscriber 2 in each case. The reproduced data packets 4 are identical to one another and have the same identification means 5.

With reference to FIG. 1, the subscriber 2.1 therefore sends the data packet 4 to its adjacent subscribers 2.2 and 2.3. Here, only subscribers 2 which are interconnected by a connection 3 are to be considered adjacent subscribers 2. The subscribers 2.2 and 2.3, which have received the data packet 4 in this step, read out the identification means 5 of the data packet 4. Each of the receiving subscribers 2.2, 2.3 now determines whether the data packet 4 has already previously been received or sent. As each subscriber records the identification means 5 of all the data packets 4 which it has previously already seen, i.e. sent or received, the determination may take place by way of a comparison with the recorded identification means 5. Each receiving subscriber 2.2, 2.3 therefore compares the identification means 5 of the new data packet 4 with the identification means 5 of the “old” data packets 4. According to the invention, the data packet 4 is then only forwarded by a subscriber 2 when it has not yet previously been received and/or sent by said subscriber 2.

As the subscriber 2.2, 2.3 had not yet received the data packet 4 in the data transfer shown in FIGS. 1-6, the data packet 4 is forwarded by the subscribers 2.2 and 2.3 to the adjacent subscribers 2.4, 2.5, as shown in FIG. 2. As the subscriber 2.3 has only one further adjacent subscriber 2.5, the data packet 4 does not have to be reproduced here.

In the data transmission shown in the figures, the data packet 4 is not sent back to the adjacent subscriber 2 from which it has previously been received in each case.

As the subscriber 2.2 has two further adjacent subscribers 2.4, 2.5, the data packet 4 is duplicated by the subscriber 2.2. The forwarding of the data packet 4 to the subscribers 2.4 and 2.5 is shown in FIG. 2.

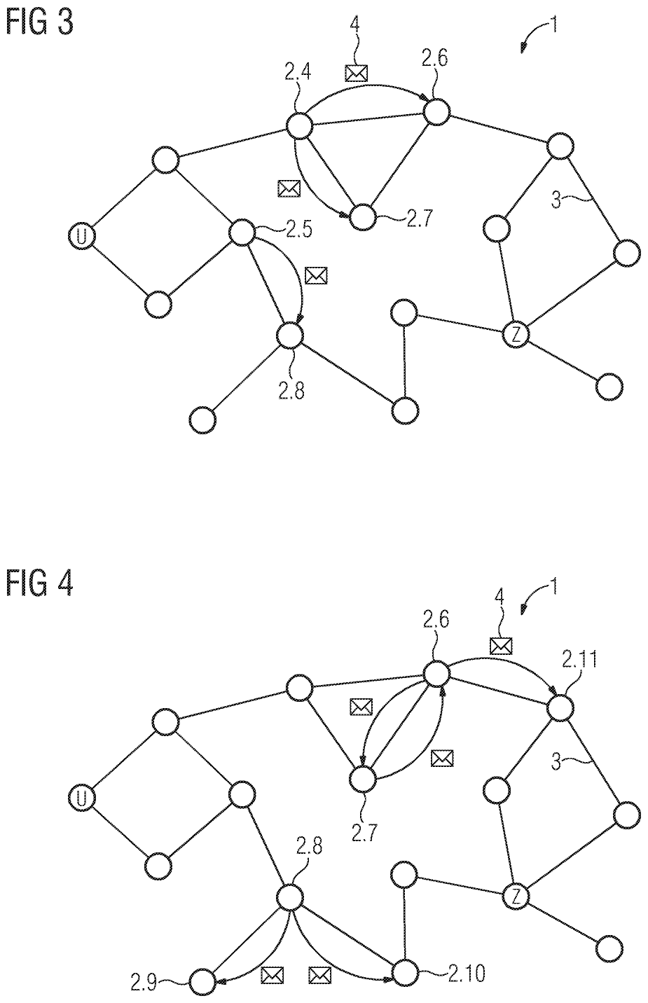

FIG. 3 shows the next step of the data transfer of the data packet 4 from the subscribers 2.4 and 2.5 to their adjacent subscribers 2.6, 2.7 and 2.8. The subscriber 2.5 had obtained the data packet 2 twice, namely both from the subscriber 2.3 and from the subscriber 2.2, as shown in FIG. 2. The two data packets 4 are identical. According to the invention, for the data packet 4 received first from subscriber 2.5, it is checked whether said data packet has already been received from or sent by said subscriber. As this was not yet the case, the data packet 4 is forwarded to the sole adjacent subscriber 2.8, as shown in FIG. 3. The second received data packet 4, however, is deleted by the subscriber 2.5 and is not forwarded, because the result of the check here is that the data packet 4 has already previously been received. Namely, the identification means 5 of the second data packet 4 has been recorded by subscriber 2.5 and its repeat receipt has been detected. Due to the deletion of the second data packet 4, the loading of the network 1 is advantageously reduced.

FIG. 4 shows the next step of the data transfer shown, in which the subscribers 2.6, 2.7 and 2.8 forward the data packets 4 to the next adjacent subscribers 2.9, 2.10 and 2.11. Here, the subscriber 2.6 duplicates the data packet 4, in order to be able to forward it to its adjacent subscribers 2.7 and 2.11 in each case. The subscriber 2.7 deduplicates, i.e. deletes the data packet 4 once, as it obtains the data packet 4 both from subscriber 2.4 and from subscriber 2.6. The subscriber 2.8 in turn duplicates the data packet 4, in order to be able to forward it to its adjacent subscribers 2.9 and 2.10.

Once again, FIG. 5 shows the next step of the data transfer, in which the subscribers 2.10 and 2.11 forward the data packet 4. The subscriber 2.10 sends the data packet 4 to its sole new adjacent subscriber 2.14. The subscriber 2.10 therefore neither has to copy the data packet 4 nor delete it. The subscriber 2.11, by contrast, has two new adjacent subscribers 2.12 and 2.13. For this reason, the subscriber 2.11 reproduces the data packet 4, in order to be able to forward it to the subscribers 2.12 and 2.13 in each case.

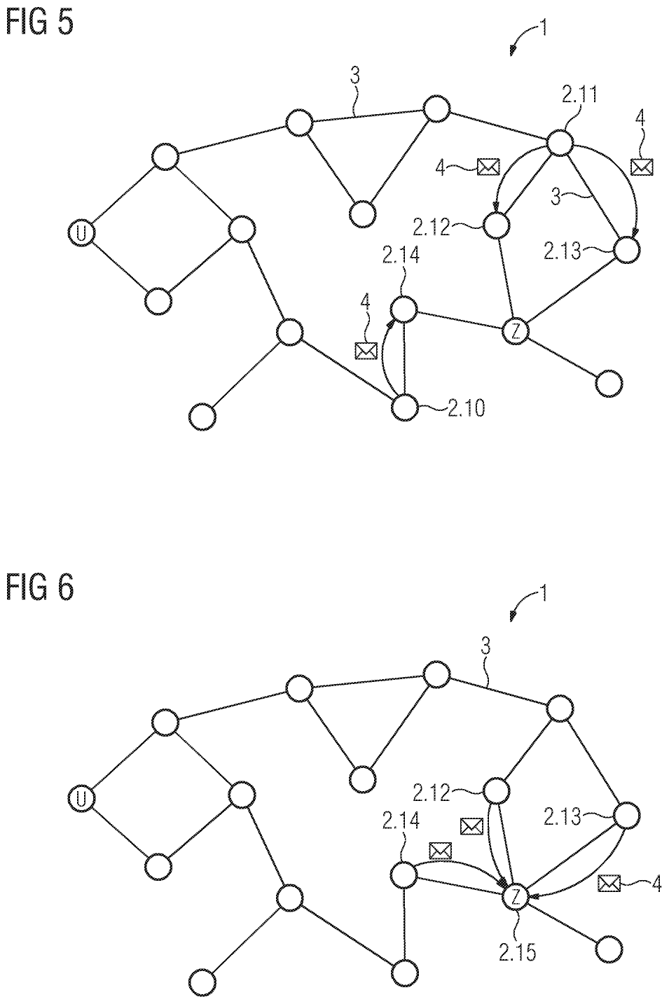

In FIG. 6, the data packet 4 reaches its goal Z, which exists in subscriber 2.15. The subscribers 2.12, 2.13 and 2.14 namely each send the data packet 4 to their sole new adjacent subscriber 2.15. As the subscriber 2.15 is the destination Z of the data packet 4, the data transfer according to the invention ends here.

In FIGS. 1-6, by way of example, the destination of the data transfer is a single subscriber 2.15. For this reason, this involves a Unicast or Anycast data transfer. Alternatively, however, the method according to the invention may also be used for data transfer to a defined subset of the subscribers in accordance with the Multicast method, or also to all subscribers 2 in accordance with the Broadcast method.

The network 1 according to the invention shown by way of example in FIGS. 1-6 is configured as an ad hoc network, where the invention has proven to be particularly advantageous. Other forms of network are of course likewise possible. The method according to the invention naturally also functions for other forms of network.

By way of the method according to the invention, all possible paths between the origin U and the destination Z are used. As a result, a high Quality of Service is ensured without having to use additional error-correcting algorithms.

The data packet 4 has a data volume greater than 1 KB. For this reason, a sufficient volume of useful data can be transferred in the data packet 4. As a result, using the method according to the invention, a large number of data packets 4 can be transmitted per unit of time, for example per second, within the network 1.

1-10. (canceled)

11. A method for data transmission in a network having a plurality of subscribers, which comprises the steps of:
sending a uniquely identifiable data packet by at least one first subscriber to all adjacent second subscribers;
determining in each of the second subscribers in which the data packet is received whether the data packet has previously already been received and/or sent by each said second subscriber; and
sending the data packet by each second subscriber to all adjacent third subscribers if the second subscriber had not yet previously received and/or sent the data packet.

12. The method according to claim 11, wherein a received said data packet is not sent by each of the second subscribers when the second subscriber had previously already received and/or sent the data packet, or the second subscriber is a sole destination of the data packet.

13. The method according to claim 12, wherein the data packet received is deleted if the second subscriber had previously already received and/or sent the data packet.

14. The method according to claim 11, wherein a data volume greater than 128 bytes can be sent or received together by means of the data packet.

15. The method according to claim 11, which further comprises determining with an aid of an identification means, which the data packet has, whether the second subscriber had already previously received and/or sent the data packet.

16. The method according to claim 11, wherein the data packet is not sent back to the first subscriber by each of the second subscribers.

17. A subscriber system for receiving and transmitting data packets in a network having of a plurality of subscriber systems, the subscriber system comprising:
a subscriber embodied to receive a data packet transmitted by an adjacent subscriber and to determine whether the data packet has previously already been received and/or sent by the subscriber; and
said subscriber embodied to send the data packet to all adjacent subscribers if said subscriber has not yet previously received and/or sent the data packet.

18. A network for transmitting data packets, the network comprising:
a plurality of subscribers, at least some of said subscribers are configured to:
receive a data packet transmitted by an adjacent subscriber of said plurality of subscribers and to determine whether the data packet has previously already been received and/or sent by a respective subscriber of said plurality of subscribers; and
said respective subscriber embodied to send the data packet to all adjacent subscribers of said plurality of subscribers if said respective subscriber has not yet previously received and/or sent the data packet.

19. The network according to claim 18, wherein the network is configured as an ad hoc network.

20. The network according to claim 18, wherein the network is configured within a railway engineering system, an industrial facility or a road traffic system.
